(19) United States
(12) Patent Application Publication
(10) Pub. No.: US 2006/0102482 A1
(43) Pub. Date: May 18, 2006

(54) Fluidic system

(76) Inventors: Janko Auerswald, Luzern (CH); Helmut Knapp, Ebikon (CH)

Correspondence Address: FISH & RICHARDSON, PC, P.O. BOX 1022, MINNEAPOLIS, MN, 55440-1022, US

(21) Appl. No.: 10/527,389

(22) PCT Filed: Sep. 11, 2003
(86) PCT No.: PCT/EP03/10206

§ 371 Date: Sep. 7, 2005

(30) Foreign Application Priority Data
Sep. 13, 2002 (GB) 0221339.5

(51) Int. Cl. B03C 5/02

(52) U.S. Cl. 204/547; 204/643

(57) ABSTRACT

A fluidic system for analysing biomolecules in solution comprises a microchannel (21) having a inlet port (22) and an outlet port (23) across which extends a set of interdigitated electrodes (24) to which an AC voltage source having a voltage of 0-20V and a frequency of 100 Hz to 20 MHz. A fluid flow (25) through the microchannel (21) carries functionalised microbeads (26) and by applying the appropriate AC voltage and frequency to the electrodes (24) the microbeads (26) can be retained at the site of the electrodes (24) to form a packed bed (27). The packed bed (27) of microbeads is then subsequently perfused with a sample containing the analyte (28) specifically bound by the ligand immobilised on the microbeads. The analyte is separated and concentrated by the packed microbeads and can be detected directly or indirectly by further perfusion of labelled reagent molecules.

The invention relates to a fluidic system for analysing biomolecules and to a method of analysing biomolecules.

The invention is applicable to materials and methods for the analysis of biomolecules, such as antibodies, antigens, enzymes, and proteins, in fluid samples using solid-phase assays. The invention has particular, but not exclusive, utility when performing analyses using packed microbeads using liquids for suspending the microbeads and for analysing liquid samples.

Microparticles, which may take the form of microbeads that can be made of a variety of materials, such as glass, polystyrene, or other polymers may be utilized as solid phase assays when coated with the appropriate ligand for binding the molecular species to be analysed.

Flowing a sample containing the molecular species of interest, called analyte hereafter, through a bed of microbeads speeds the reactions between the analyte and the ligand immobilized on the surfaces of the microbeads. The increased reactive surface area, the reduced diffusion distance, and the stirring of the sample due to the turbulent flow within the bed of beads cause this enhancement in reactivity. The immediate advantages are a higher sensitivity, a shorter analysis time, and a reduced consumption of analyte and reagents. The use of such packed microbeads in microfluidic systems enhances these advantages even further.

Separation and concentration of biomolecules such as proteins, chromosomes, nucleic acids, and the like is important in various detection, isolation, and quantification tests in biochemistry and diagnostics. Specifity, sensitivity, and time are the important parameters in the separation and concentration schemes. Furthermore, a low consumption of sample and reagents makes tests less invasive for a patient and cheaper, respectively.

Microfluidic systems require only small amounts of sample and reagents and the small volumes can be handled with better precision than in conventional macroscopic systems, reducing the costs and error rates of analysis. The high surface to volume ratio in microfluidic systems speeds reactions and creates conditions more relevant to biological ones. To enable analyte-ligand tests within such systems, the ligand has to be brought into the system either by directly functionalising defined parts of the microfluidic channel walls or by introducing and retaining functionalised microbeads. The latter option not only allows the use of microbeads which can be functionalised by standard techniques in large quantities outside the microfluidic system, but also enhances the sensitivity and reaction speed because of the sieve-like function of a packed bed of microbeads within a microfluidic channel.

WO 01/34302 “Biochannel Assay for Hybridization with Biomaterial” describes the use of microchannels that have separated regions with specific ligands bound to porous polymer, beads or structures fabricated into the microchannels to function as a solid phase assay, but does not describe how beads can be introduced and retained in the microchannels. Retaining the microbeads in the microchannels can be a difficult task.

U.S. Pat. No. 6,120,734 “Assay System”, WO 00/50172 “Manipulation of Microparticles in Microfluidic Systems”, and Oleschuk et al., Trapping of Bead-Based Reagents within Microfluidic Systems: On-Chip Solid-Phase Extraction and Electrochromatography, Analytical Chemistry 2000, 72, 585-590 describe the use of microparticles in microfluidic systems as solid-phase assays and employ physical barriers for bead retention. Such physical barriers for microbeads are difficult to fabricate, can be applied to only a certain size range of beads, and the beads cannot easily be removed or further manipulated.

Another method for bead retention is the use of magnetic forces (Fan et al., Dynamic DNA Hybridization on a Chip Using Paramagnetic Beads, Analytical Chemistry, 1999, 71, 4851-4859; U.S. Pat. No. 5,972,721 “Immunomagnetic Assay System for Clinical Diagnosis and other Purposes”). However, this method requires special microbeads with magnetic properties and bulky sources for generating the magnetic fields, which are difficult to integrate into microfluidic systems.

The invention provides a fluidic system for analysing biomolecules comprising an inlet port, an outlet port, a set of microelectrodes within a channel connecting the inlet and outlet ports, means for flowing a fluid through the fluidic system, means for flowing a suspension of a given type of microparticles through the fluidic system, means for applying an AC voltage having an appropriate frequency for retaining a given type of microparticles in the region of the electrodes by means of positive (attractive) dielectrophoresis, the microparticles being functionalised with appropriate ligand molecules, and means for flowing a sample fluid containing the analyte specifically bound by the ligand molecules on the microparticles through the fluidic system, thereby perfusing the retained microparticles.

Various preferred, advantageous, and/or alternative features of the invention are set out in the dependent claims to which reference should now be made.

Dielectrophoresis is a method where a force can be applied to dielectric particles in order to manipulate them. This force is caused by an electric field, which can be generated by an AC-voltage applied to microelectrodes. Particles will either be attracted to or repelled from the microelectrodes depending on the dielectric properties of the particles and their surrounding medium and the frequency of the applied voltage (see for example Pohl, Dielectrophoresis, Cambridge University Press, Cambridge, 1978). For a given set of particles and suspending medium, the magnitude and direction of the dielectrophoretic force can be tuned with the frequency of the applied voltage, allowing one to choose and separate specific particle types from a mixed suspension.

WO 02/31179 “Multiplex Assays using Nanoparticles” describes using a microfluidic device with microelectrodes to separates nanoparticles by dielectrophoresis, after the nanoparticles have bound analyte molecules by specific interaction. The device uses the change in dielectric properties upon analyte binding to detect the presence of said analyte, but does not generate a packed bed of beads to function as a solid phase assay.

U.S. Pat. No. 6,352,838 “Microfluidic DNA Sample Preparation Method and Device” describes using dielectrophoresis for capturing target material within a microdevice, said target material being DNA, spores, bacteria or polystyrene beads. It does not describe capturing microbeads by dielectrophoresis and subsequently perfusing them with sample containing the analyse.

WO 99/62622 describes a method and apparatus for cell or particle concentration, positioning or separation utilizing negative dielectrophoresis and controlled heat convection. Both effects result in a repulsion of the cells or particles from and levitation above the electrodes.

WO 02/27909 describes a particle switch based on travelling wave dielectrophoresis to transport and redirect microparticles such as cells, beads or molecules utilizing different intersecting arrays of interdigitated electrodes. The particles are levitated above the electrodes by negative dielectrophoresis and moved along the electrode arrays by traveling electric fields.

WO 02/088702 describes a particle manipulation device using movable dielectrophoretic field cages. Dielectrophoretic field cages are generated by electrodes surrounding the particle. The electrodes are supplied with an AC voltage imposing negative (repelling) dielectrophoretic forces on the particle thus trapping it in the middle between the surrounding electrodes. Movable field cages can be achieved using arrays of individually addressable electrodes. In contrast to all of these disclosures using negative (repelling) dielectrophoretic forces, in the present invention, the functionalised beads are immobilized on the electrode edges by positive dielectrophoresis (attractive forces) or positive-dielectrophoresis-enhanced adhesion to form a solid state surface for the following assay procedure.

US patent application 2002/0076825 and PCT application WO 02/30562 (same patent family) describe integrated biological sample processing and analysis on one or more chips. Among other physical effects exerting forces on particles, e.g. magnetic fields, acoustic fields or magnetophoretic traveling wave fields, dielectrophoresis and traveling wave dielectrophoresis are used to separate or to transport particles such as cells, cell organelles, biomolecules or bead, respectively. In contrast to that, the present invention uses dielectrophoresis and dielectrophoresis-enhanced adhesion in order to immobilize functionalist beads on electrodes to form a specific solid phase substrate for further biochemical detection and analysis.

US patent application 6 333 200 describes an immuno-agglutination assay based on functionalised beads (e.g. latex beads with protein A coating). Dielectrophoresis is used to pre-concentrate the beads in the vicinity of the interelectrode gaps, whereas an additional coagulation agent is required to permanently immobilize the beads in the gaps between the electrodes. Antibodies, such as human IgG, bind specifically to the immobilized beads. For detection, colloidal gold particles labeled with appropriate anti-antibodies (e.g. goat anti-human IgG) bind to the captured antibodies and are permanently fixed to them using a glutaraldehyde. Finally a silver layer is deposited onto the gold colloids enlarging an fusing them together thus bridging the gap between the electrodes with a conductive metal layer. The electrical current or resistance between the electrodes can be measured. The difference between this disclosure and the invention disclosed herein include a different immobilization mechanism (immobilization in interelectrode gaps using a coagulation agent following a dielectrophoretic pre-concentration step versus dielectrophoretic or dielectrophoresis-enhanced adhesive immobilization of functionalised beads at the electrode edges) and in a different detection mechanism (formation of a metallic layer and measurement of electrical current/resistance versus fluorescence detection of markers attached to the analyte).

Besides the general advantages of microfluidic systems using microbeads mentioned above, one or more embodiments of a system according to the invention have some or all of the following advantages:
a) preconcentration of beads is possible in microchannels without physical barriers or bulky magnetic field generating apparatus;
b) once an assay has been finished, the used beads can be removed from the microchannels and fresh beads may be brought in, that is the device can be reused;
c) the system is versatile, because the actual test performed can be chosen by the introduction of microbeads functionalised with the appropriate ligand. The microchannels of the microfluidic system remain the same, reducing production costs for such systems; and
d) several bead retaining sites can be formed within the microchannels by successive activation of dielectrophoresis areas, creating the possibility of multistep analysis and multistep analysis on a single device.

The present invention provides a microfluidic system capable of retaining and concentrating microparticles, which may take the form of microbeads, in defined locations within the microfluidic channels, thereby creating a packed bed of microbeads. Retaining and accumulation of the microbeads may be accomplished without any physical barriers by integration of microelectrodes producing dielectrophoresis into the microchannels. By choosing the appropriate voltage and frequency applied to the microelectrodes, the dielectrophoretic retaining force can be tuned to retain only microbeads with specific dielectric properties. Subsequently, the retained microbeads can be perfused with liquids containing analytes, reagents, rinsing buffers, etc. If the microbeads are functionalised with molecules specific to a given analyte, such a system can act as a micro-assay for the given analyte. Detection of the analyte can be done at the bead retention site by any convenient techniques, for example fluorescence. After analyte detection has been completed, the beads can easily be removed from the microfluidic system by switching off the voltage applied to the microelectrodes and rinsing the microchannels with a buffer solution.

In an alternative embodiment of the invention, the microbeads can be released from the retaining electrodes after analyte accumulation for analyte detection at a different bead retaining location within the microfluidic system. This would, for example allow for a further concentration of beads in a smaller area, thus simplifying optical detection techniques, or enable analysis of individual beads by cytometry.

In a further alternative embodiment the AC voltage may be arranged to be applied to the electrodes for a sufficient time to cause at least some of the microparticles to adhere to the electrodes when the AC voltage is removed.

This has the advantage that high conductivity analyte solutions can be used. Thus real body fluids such as blood, serum, saliva amniotic, cerebrospinal, or pleural fluids having typical mean conductivities of 500-2000 m5/m can be used. Consequently, no dilution of body fluids containing analyte molecules is necessary.

The invention further provides a method for analysis of biomolecules comprising the steps of:
a) providing a fluidic system having an inlet and outlet port and containing a set of microelectrodes and a means of moving liquid through the fluidic system;
b) applying an AC voltage to said electrodes with an appropriate frequency for retaining in the region of the electrodes a given type of microparticles which are functionalised with appropriate ligand molecules by positive (attractive) dielectrophoresis;
c) flowing a suspension of said type of microparticles through the fluidic system and retaining the microparticles at the microelectrodes by means of positive dielectrophoresis;
d) flowing a sample liquid containing the analyte specifically bound by the ligand molecules on the microparticles through the fluidic system, thereby perfusing the retained microparticles; and
e) detecting the presence of analyte bound to the microparticles.

In step c) a plurality of types of microparticle having different dielectric properties may be flowed through the fluidic system and the type of microparticle specified by the choice of frequency in step b) is retained at the microelectrodes by means of dielctrophoresis.

In one embodiment of the invention in step c) the microparticles are retained on the electrodes during the performance of steps d) and e) by maintaining the AC voltage applied to the electrodes while steps d) and e) are performed.

This embodiment has the advantage that the analysis may be carried out comparatively quickly, but since the AC voltage has to be maintained throughout the analysis a low conductivity analyte solution, i.e. less than 100 mS/m, is necessary. Normal body fluids have a higher conductivity and it is therefore necessary to dilute them to obtain a sufficiently low conductivity. Dilution, however, may cause harm to or change the analyte molecules in body fluids.

In an alternative embodiment the AC voltage is maintained for a sufficient time that at least some of the microparticles are caused to adhere to the electrodes when the AC voltage is removed and steps d) and e) are performed subsequent to the removal of the AC voltage from the electrodes.

This embodiment, which uses a novel technique of DEP enhanced adhesion, has the advantage that since the AC voltage is removed during analysis high conductivity analyte solutions can be used. Thus typical body fluids such as blood, serum, saliva, amniotic, cerebrospinal, or pleural fluids that typically have mean conductivities of the order of 500-200 mS/m can be analysed without needing dilution. The analysis is, however slower since the DEP enhanced adhesion has to take place before analysis can be carried our and typically can take more than fifteen minutes to immobilize sufficient micro particles.

Various preferred, advantageous, and/or alternative features of the method according to the invention are set out in the dependent claims to which reference should now be made.

The above and other features and advantages of the invention will be apparent from the following description, by way of example, of an embodiment of the invention with reference to the accompanying drawings, in which:

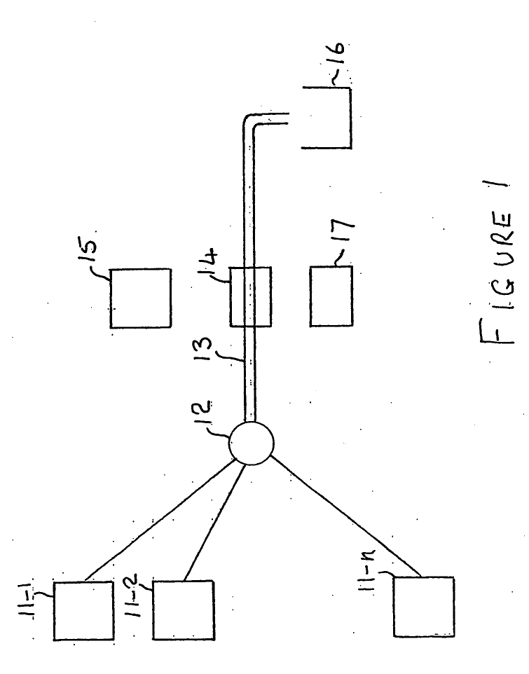

FIG. 1 shows in block schematic form a system for analysing biomolecules in solution according to the invention, and

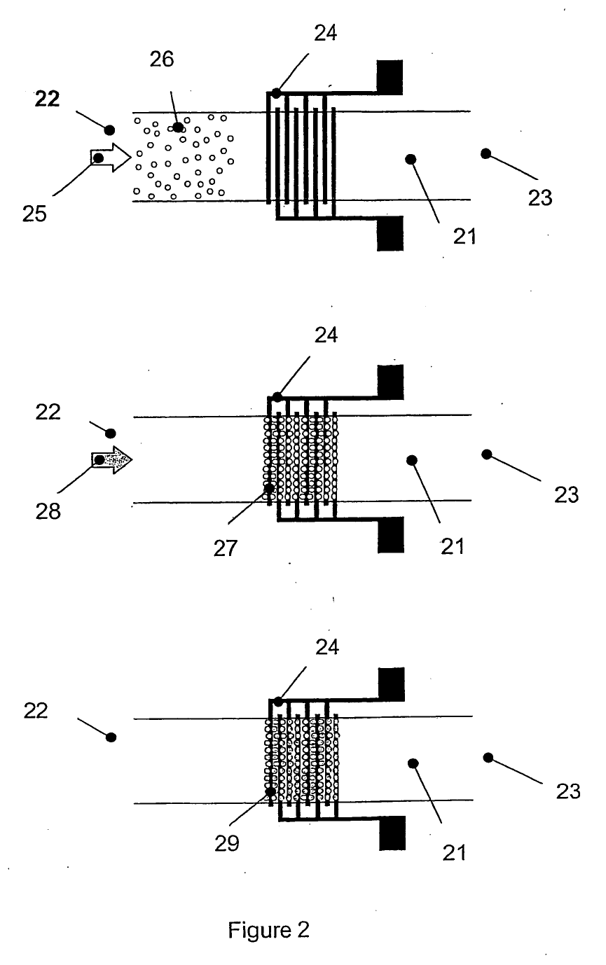

FIG. 2 shows in greater detail a microchannel, input and output ports, and interdigitated electrodes forming part of the system of FIG. 1.

As shown in FIG. 1 the system comprises a plurality of reservoirs 11-1, 11-2, . . . 11n for containing microbeads, reagents, buffers, samples, etc. A pump 12, which may be of any convenient form, but is typically a syringe pump is used to introduce the appropriate materials into a channel 13. The channel 13 contains an interdigitated set of electrodes 14 which have an AC voltage applied across them by means of an AC voltage generator 15. A drain 16 collects the waste material after it has passed through the channel 13. A detector 17 is provided to detect the analyte on the beads at the site of the electrodes. Thus FIG. 1 shows of a microfluidic system containing a dielectrophoretic retention site for microparticles.

This system could be modified in a number of ways, some of which are set forth below.
1) There may be more than one retention site within a micro channel allowing analyses using different microbeads that are attracted to one of a plurality of sets of electrodes, each set being supplied with an AC voltage having a given frequency that causes a given type of microparticle to be retained.
2) A plurality of microchannels could be provided with the pump outlet being switched between the microchannels.
3) The detector may be at a different location from the retention site formed by the electrodes 14.
4) It would also be possible to elute the analyte from the retention site for introduction into a capillary electrophoresis column. The advantage of the prior analyte binding to the microbeads would be a preconcentration of analyte.
5) The AC voltage generator may have a fixed frequency where only one type of microparticle is to be retained or may be of variable frequency to enable it to be tuned to the particular type of microparticle it is desired to retain.
6) The AC voltage generator may have a plurality of outputs, which may be of different frequencies, to allow simultaneous retention of different types of microparticles on different sets of electrodes, either at different positions along the length of a single microchannel or on different microchannels.
7) While the embodiment has been designed for use with the microbeads flowing in a liquid they could be suspended in a gas but the microbeads would have to be smaller in order to enable them to be suspended in the gas.
8) While interdigitated electrodes are shown for retaining the microbeads electrodes of any other from that would retain the microbeads could be used.

FIG. 2 shows part of the microfluidic system in its simplest form of a single microchannel 21 having with an inlet port 22 and outlet port 23 and containing a set of interdigitated microelectrodes 24, which can be powered with an AC voltage of 0-20V and 100 Hz to 20 MHz. As shown in FIG. 2a fluid flow 25 through the microchannel 21 can be used to introduce microbeads 26, which have been functionalised with appropriate ligand molecules. The diameter of the beads may be chosen to be within the range of 100 nm to 10 m. If as shown in FIG. 2b, the microelectrodes 24 are powered with the appropriate voltage and frequency for retaining the functionalised microbeads 26, the microbeads 26 will form a packed bed 27, which will function as a solid-phase microbead array. This packed bed 27 can subsequently be perfused with a sample containing the analyte 28 specifically bound by the ligand immobilized on the microbeads. As shown in FIG. 2c the analyte will be separated and concentrated by the retained beads 29 and can be detected directly or indirectly by further perfusion of labeled reagent molecules.

In a non-limiting example embodiment of the invention, the microfluidic system consists of the single microchannel 21 between 100 μm and 4 mm wide, less than 30 μm high, and 10 mm long. Interdigitated electrodes 24 have 10 μm width and 10 μm spacing and span the entire length of the microchannel. Fluid is pumped through the microchannel with a syringe pump 12 generating a flow rate of up to 10 mm/s. A 2.5% suspension of streptavin labeled 2 μm polystyrene beads is diluted at a ratio of at least 1:10 in an aqueous buffer solution with a conductivity of less than 1000 mS/m, called working solution hereafter. If a voltage of 16V and at 100 kHz is applied to the interdigitated electrodes, the 2 μm beads will be retained at the electrodes by positive dielectrophoresis, thus forming a packed bed of microbeads. While keeping the voltage applied to the interdigitated electrodes, the bead bed can first be rinsed by flowing working solution through the microchannel to remove unbound microbeads and secondly be perfused with the analyte by flowing fluorescein labeled biotin solved in the working solution through the microchannel. The microchannel can then be rinsed with pure working solution to remove excess biotin molecules. Finally, the amount of bound biotin can be detected with a fluorescence light microscope.

The above example disclosed a micro assay based on the dielectrophoretic retention of Functionalised beads comprising the following steps:
Retention of Functionalised beads at electrodes by positive dielectrophoresis (DEP).
Incubation with fluorescently marked analyte molecules which are or are labeled with the counter-molecule of bead functionalisation (e.g. biotin coated beads for the detection of fluorescently labeled streptavidin molecules or of (bio-) molecules marked with streptavidin and a fluorescent label).
Flushing away of excess analyte.
Detection of the fluorescence signal coming from the bead surfaces after the reaction with the analyte molecules.

A further example modifies the above process in the following way:
First, the beads are brought in contact with the electrodes by positive DEP.
The DEP is continued for 10-15 minutes to make a number of beads stick to the electrodes by adhesion.
Then, DEP can be turned off. The non-sticking beads are flushed away, but the beads sticking through adhesion will stick there throughout the entire assay procedure forming the solid functionalised phase required for the binding reaction with the analyte molecules at a pre-defined location (the electrode edges).

The rest of the micro assay sequence remains the same, i.e.
Incubation with fluorescently labeled analyte molecules.
Flushing away of excess analyte.
Detection of the fluorescence signal coming from the bead surfaces after the reaction with the analyze molecules.

To ensure a maximum number of bound beads, the DEP enhanced adsorption process may be cycled; i.e. the beads are first bound to the electrode surfaces by a positive DEP setting, then any beads not bound to the surface are pushed away by a negative DEP setting. This cycle is repeated a few times to ensure the beads are truly bound to the surface to withstand flushing with rinsing buffer, analyte, and reagents.

The further example has the advantage that to bring the beads in contact with the electrodes by positive DEP requires a low-conductivity bead suspension (<100 mS/M or often <10 mS/m) to make sure that the DEP retains the microbeads sufficiently strongly. Once a number of beads stick by adhesion at the electrode edges, after 10-15 minutes of positive DEP, the DEP voltage can be removed and it is no longer necessary to keep the conductivity low throughout the rest of the assay. Therefore, the analyte solution containing the molecules of interest may have a physiological conductivity (typical values for human body fluids are 500-2000 mS/m) and does not have to be diluted to lower conductivities.

In practice when using the process of the second example the apparatus is restricted to a single analysis as the microbeads are retained effectively indefinitely.

When used in the diagnostics market, however, the devices should be disposable anyway (i.e. only be used once). It is possible to retain dielectrically different types of beads at different locations within the microchannel. These locations may all have the same type of microelectrode design, but can be addressed with appropriate DEP frequencies to individually collect a selected bead type. In other words, a mixture of e.g. three dielectrically different bead types, also functionalised with three different molecular probe types, respectively, can be introduced into a microchannel containing three separated sites with microelectrodes. Three different DEP frequencies, corresponding to the three dielectrically different bead types, can be applied to the three electrode sites, respectively. This will render the three electrodes sites each “functionalised” with a different bead type. Thus an analyte solution could be tested for three different analytes simultaneously.

The examples described above are intended to illustrate the functionality of the present invention and not to limit it in spirit or scope. The system may be operated with any analyte-ligand system.

1. A fluidic system for analysing biomolecules comprising an inlet port, an outlet port, a set of microelectrodes within a channel connecting the inlet and outlet ports, means for flowing a fluid through the fluidic system, means for flowing a suspension of a given type of microparticles through the fluidic system, means for applying an AC voltage having an appropriate frequency for retaining a given type of microparticles in the region of the electrodes by means of positive (attractive) dielectrophoresis, the microparticles being functionalised with appropriate ligand molecules, and means for flowing a sample fluid containing the analyte specifically bound by the ligand molecules on the microparticles through the fluidic system, thereby perfusing the retained microparticles.

2. A system as claimed in claim 1 comprising means for flowing a plurality of types of microparticles with different dielectric properties through the fluidic system, and means for applying different frequency voltages to the electrodes to retain selected ones of the types of microparticles.

3. A system as claimed in claim 2 comprising a plurality of sets of microelectrodes within the channel at spaced intervals, and means for applying voltages of selected frequencies to each of the sets of electrodes to retain selected types of microparticles at the electrodes.

4. A system as claimed in claim 1 comprising means for detecting the presence of the analyte bound to the microparticles at the retention site of the microparticles.

5. A system as claimed in claim 1 comprising means for flowing a solution containing reagent molecules specific to the analyte molecules through the fluidic system to perfuse the analyte bound by the ligand molecules on the microparticles.

6. A system as claimed in claim 5 in which the presence of reagent molecules bound to the microparticles is detected at the retention site of the microparticles.

7. A system as claimed in claim 1 comprising means for flowing a rinsing liquid through the fluidic system to remove unbound microparticles and analyte molecules, respectively.

8. A system as claimed in claim 1 comprising means for removing the AC voltage from the microelectrodes to release the microparticles and means for detecting the presence of analyte bound to the microparticles at a site separate from the interdigitated electrodes.

9. A system as claimed in claim 1 in which the fluidic system comprises a support with microstructured microelectrodes and structured microchannel(s), the support being of non-conducting material, such as glass or silicon, or a conducting material wherein each microchannel is coated with a non-conducting material, such as glass, silicon, PMMA, PDMS or other polymer.

10. A system as claimed in claim 1 in which the microparticles consist of polystyrene microbeads with diameters between 100 nm and 10 μm.

11. A system as claimed in claim 1 in which the fluid flow is generated by a syringe pump.

12. A system as claimed in claim 1 comprising a means for detecting the presence of the analyte bound to the microparticles, wherein the detecting means comprises a fluorescence microscope.

13. A system as claimed in claim 12 in which the ligand bound to the microparticles is strepavidin and the analyte contained in the sample liquid is flourescein labelled biotin.

14. A system as claimed in claim 1 comprising means for applying the AC voltage to the electrodes for a sufficient time to cause at least some of the microparticles to adhere to the electrodes and means for removing the AC voltage before flowing the sample fluid through the fluidic system.

15. A system as claimed in claim 1 in which the microelectrodes comprise interdigitated electrodes extending across the channel.

16. A method for analysis of biomolecules comprising the steps of:
a) providing a fluidic system having an inlet and outlet port and containing a set of microelectrodes and a means of moving fluid through the fluidic system;
b) applying an AC voltage to said electrodes with an appropriate frequency for retaining in the region of the electrodes a given type of microparticles which are functionalised with appropriate ligand molecules by positive (attractive) dielectrophoresis;
c) flowing a suspension of said type of microparticles through the fluidic system and retaining the microparticles at the microelectrodes by means of positive dielectrophoresis;
d) flowing a sample fluid containing the analyte specifically bound by the ligand molecules on the microparticles through the fluidic system, thereby perfusing the retained microparticles; and
e) detecting the presence of analyte bound to the microparticles.

17. A method as claimed in claim 16 in which in step c) a plurality of types of microparticle having different dielectric properties are flowed through the fluidic system and the type of microparticle specified by the choice of frequency in step b) is retained at the microelectrodes by means of dielectrophoresis.

18. A method according to claim 17 in which the presence of the analyte bound to the microparticles is detected at the retention site of the microparticles.

19. A method according to claim 16 in which after step d) a solution containing reagent molecules, specific to the analyte molecules, is flowed through the fluidic system, thereby perfusing the analyte bound by the ligand molecules on the microparticles.

20. A method according to claim 19 in which the presence of reagent molecules bound to the microparticles is detected at the retention site of the microparticles.

21. A method according to claim 16 in which after steps c) and d) a rinsing liquid is flowed through the fluidic system to remove unbound microparticles and analyte molecules, respectively.

22. A method according to claim 21 in which the presence of the analyte bound to the microparticles is detected at the retention site of the microparticles.

23. A method according to claim 21 in which after the rinsing after step d) a solution containing reagent molecules, specific to the analyte molecules, is flowed through the fluidic system, thereby perfusing the analyte bound by the ligand molecules on the microparticles and after this step, a rinsing liquid is flowed through the fluidic system for removing unbound reagent molecules.

24. A method according to claim 23 in which the presence of reagent molecules is detected at the retention site of the microparticles.

25. A method according to claim 16 in which in step c) the microparticles are retained on the electrodes during the performance of steps d) and e) by maintaining the AC voltage applied to the electrodes while steps d) and e) are performed.

26. A method according to claim 16 in which the AC voltage is maintained for a sufficient time that at least some of the microparticles are caused to adhere to the electrodes when the AC voltage is removed and steps d) and e) are performed subsequent to the removal of the AC voltage from the electrodes.

27. A method according to claim 26 in which the time is greater than ten minutes.

28. A method according to claim 24 in which the microparticles are released after analyte binding by removing the AC voltage from the microelectrodes and in which the presence of analyte bound to the microparticles is detected at a separate site within the fluidic system.

29. A method according to claim 24 in which the microparticles are released after analyte binding by removing the AC voltage to the microelectrodes and in which the presence of analyte bound to the microparticles is detected outside the fluidic system.

30. A method according to claim 23, where the microparticles are released after reagent binding by no longer applying the AC voltage to the microelectrodes and where the presence of reagent bound to the microparticles is detected at a different site within the fluidic system.

31. A method according to claim 23 in which the microparticles are released after reagent binding by no longer applying the AC voltage to the microelectrodes and where the presence of reagent bound to the microparticles is detected outside the fluidic system.

32. A method according to claim 21 in which the microparticles are released after rinsing by removing the AC voltage to the microelectrodes and in which the presence of analyte bound to the microparticles is detected at a separate site within the fluidic system.

33. A method according to claim 21 in which the microparticles are released after rinsing by removing the AC voltage to the microelectrodes and in which the presence of analyte bound to the microparticles is detected outside the fluidic system.

34. A method according to claim 23 in which the microparticles are released after rinsing by removing the AC voltage from the microelectrodes and in which the presence of analyte bound to the microparticles is detected at a separate site within the fluidic system.

35. A method according to claim 23 in which the microparticles are released after rinsing by removing the AC voltage from the microelectrodes and in which the presence of analyte bound to the microparticles is detected outside the fluidic system.

36. A method according to claim 16 in which the fluidic system comprises an inlet and outlet port and a support with microstructured microelectrodes and structured microchannel(s), the support being of non conducting material, such as glass or silicon, or a conducting material wherein each microchannel is coated with a non conducting material, such as glass, silicon, PMMA, PDMS, or other polymer.

37. A method as claimed in claim 16 in which the microelectrodes comprise interdigitated electrodes extending across the width of the channel.

38. A method according to claim 37 in which the interdigitated microelectrodes span the whole width of the fluidic channel, have a width between 1 and 20 μm and a gap between the electrodes between 1 and 20 μm.

39. A method according to claim 16 in which the microparticles consist of polystyrene microbeads with diameters between 100 nm and 10 μm.

40. A method according to claim 16 in which the fluid flow is generated by a syringe pump, the ligand bound to the microbeads is streptavidin and the analyte contained in the sample liquid is fluorescein labelled biotin, and in which the detection of fluorescein labelled biotin bound to the microbeads functionalised with streptavidin is carried out using a fluorescence microscope.
